(19) United States
(12) Patent Application Publication
(10) Pub. No.: US 2009/0160623 A1
(43) Pub. Date: Jun. 25, 2009

(54) METHOD FOR IDENTIFYING AN ELECTRONIC LABEL, ELECTRONIC LABEL AND BASE STATION FOR IMPLEMENTING SAID METHOD

(76) Inventor: Pierre Raimbault, Verrieres le Buisson (FR)

Correspondence Address: THE JANSSON FIRM, 9501 N. CAPITAL OF TX HWY #202, AUSTIN, TX, 78759, US

(21) Appl. No.: 11/574,961

(22) PCT Filed: Nov. 10, 2004
(86) PCT No.: PCT/FR04/02902

§ 371 Date: Jul. 14, 2008

(30) Foreign Application Priority Data
Nov. 13, 2003 (FR) 0313311

(51) Int. Cl. H04Q 5/22

(52) U.S. Cl. 340/10.42

(57) ABSTRACT

The invention relates to a method for identifying electronic labels provided with an identification code consisting of a plurality of rows, by means of a base station emitting interrogation commands (104, 108, 124, 128, 140) specifying at least one row of said code, each label emitting, in response to the base station, the value of the code thereof for each said row (110, 126, 130, 142). The inventive method consists of the following steps: the electronic labels are interrogated (104, 108), in an interrogation step, for at least one row of the code, and, if at least one electronic label emits a response (110), a signalisation step is performed by the base station when it has received two responses, the labels that do not have a pre-determined value for the interrogation row are subjected to a temporary inhibition step (114, 134) when the base station signals that it has received two responses, and a storage step (114, 134) is performed for the storage of each row in the labels that are temporarily inhibited. At least one subsequent interrogation step (124, 128, 140) is performed for each stored inhibition row.

This invention relates to a method for identifying electronic tags, electronic tags and a base station for implementing said method. It applies, in particular, to identification of objects equipped with tags communicating by radio frequency waves.

Methods for identifying RFID tags are known, such as those described in document EP 96402555.5. These methods may be too slow to identify a large number of tags moving on, for example, a fork lift truck or in another vehicle.

This invention aims to overcome these disadvantages.

Thus, this invention relates, according to a first aspect, to a method for identifying electronic tags equipped with a memory of an identification code specific to each tag, this code including a certain number of ranks, identified by a base station able to transmit interrogation commands, explicit or implicit, specifying at least one rank of said code, each tag within the range of the base station being able to transmit, in response to an interrogation command, a signal representative of the value of its code for each said rank, characterized in that it includes:

a step to interrogate the electronic tags and, on reception by the base station of the responses from the electronic tags, for at least one code rank, a transition step to move to the next rank during which the base station only transmits a signal to the electronic tags if the responses from the electronic tags represent at least two different code values for the rank interrogated;

when the base station has indicated that it has received responses representative of at least two different code values for the rank interrogated:
an inhibition step to temporarily inhibit the tags which have a predetermined code value for said interrogated rank, inhibition step after which said tag no longer responds to the interrogations until it receives a de-inhibition instruction, and
a storage step to store said rank in the tags performing the inhibition step,

for each stored inhibition rank, at least one subsequent re-interrogation step concerning said stored inhibition rank and, in response to said re-interrogation, for each tag which has stored said inhibition rank:
a de-inhibition step and
a response step representative of the value of its code in this rank or in another rank, the base station associating with each said tag a section of code common to all the tags performing said response step.

With these measures, the electronic tags are distributed into sub-groups whenever they do not have the same code value in a rank and, for each sub-group, some of the code or identifier of the tags in this sub-group is already known when these electronic tags are re-interrogated. Recognition of the tags in this sub-group is therefore faster than if all their code ranks had to be re-interrogated. In addition, since the base station only transmits a signal in one of the two cases, the method is faster than the methods known in the prior art.

According to special features, the signal transmitted by the base station on reception of the responses from the electronic tags is a silence signal during which the base station stops transmitting a magnetic field.

Since the signal simply consists of a silence, it is faster than if a frame had to be transmitted, for example to indicate the value of the code for the ranks already identified.

According to special features, the magnetic field which is no longer transmitted by the base station during the signal transmitted by the base station on reception of the responses from the electronic tags is a magnetic field powering the electronic tags.

With these measures, the downlink between the base station and the tags is restricted to the magnetic field powering the electronic tags, which simplifies the implementation of the method subject of this invention.

According to special features, the base station performs the subsequent re-interrogation steps starting with the last inhibition rank then performing a series of interrogation steps until at least one tag has been fully identified. With these measures, much of the code is already known for the tags responding to the re-interrogations. The identification speed for these tags is therefore high.

According to special features, when the code of a tag has been fully identified, said tag performs a permanent inhibition step after which said tag no longer responds to the interrogations before receiving a de-inhibition instruction.

With these measures, the number of active tags drops progressively until all tags have been identified.

According to special features, on each interrogation step, the tags determine their response transmission time according to the value of their code for the rank concerned by the response.

According to special features, at the start of a re-interrogation, the tags transmit a response which concerns the rank after that for which inhibition took place. With these measures, the tags do not transmit a response already known by the base station, if the codes are binary and the interrogations concern a single code rank.

According to a second aspect, this invention relates to an electronic tag equipped with a memory of an identification code specific to each tag, this code including a certain number of ranks, identified by a base station able to transmit interrogation commands, explicit or implicit, specifying at least one rank of said code, each tag within the range of the base station being able to transmit, in response to an interrogation command, a signal representative of the value of its code for each said rank, characterized in that it includes:

a response means to respond to an electronic tag interrogation by the base station, for at least one code rank, and, for each interrogation:

a control means able to detect a signal transmitted by the base station only if the base station has received responses representative of at least two different code values for the rank interrogated and, if this signal is detected, to determine whether said tag has a predetermined code value for said rank and, in this case, to inhibit the electronic tag, i.e. prevent it from responding to the interrogations until it receives a de-inhibition instruction,

an inhibition rank memory in which the control means stores the code rank at which the tag may switched into inhibited stated.

According to a third aspect, this invention relates to a base station to identify electronic tags equipped with a memory of an identification code specific to each tag, this code including a certain number of ranks, said base station being able to transmit interrogation commands, explicit or implicit, specifying at least one rank of said code, each tag within the range of the base station being able to transmit, in response to an interrogation command, a signal representative of the value of its code for each said rank, characterized in that it includes:

a storage means to store each “divergence” rank for which at least two tags have transmitted two different responses to said interrogation,

a communication means able, on reception by the base station of the responses from the electronic tags, for at least one code rank, to only transmit a signal from the base station to the electronic tags if the responses from the electronic tags represent at least two different code values for the rank interrogated;

control means able to re-interrogate the tags for each divergence rank stored and to associate with their response a section of code common to all the tags responding to said re-interrogation.

Since the advantages, aims and special features of this tag and base station are similar to those of the method outlined above, they are not described here.

Other advantages, aims and features of this invention will appear on reading the following description, given for a non-limiting explanatory purpose and referring to the attached drawings in which:

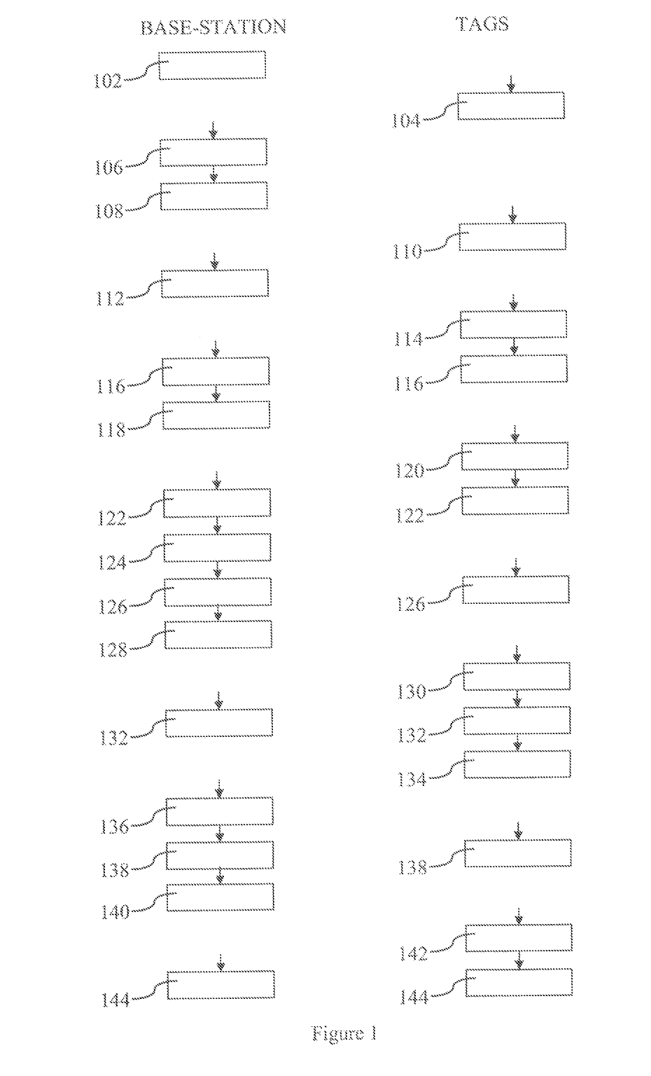

FIG. 1 represents an example of implementation of the method subject of this invention, by a series of steps performed by a base station and tags in accordance with this invention;

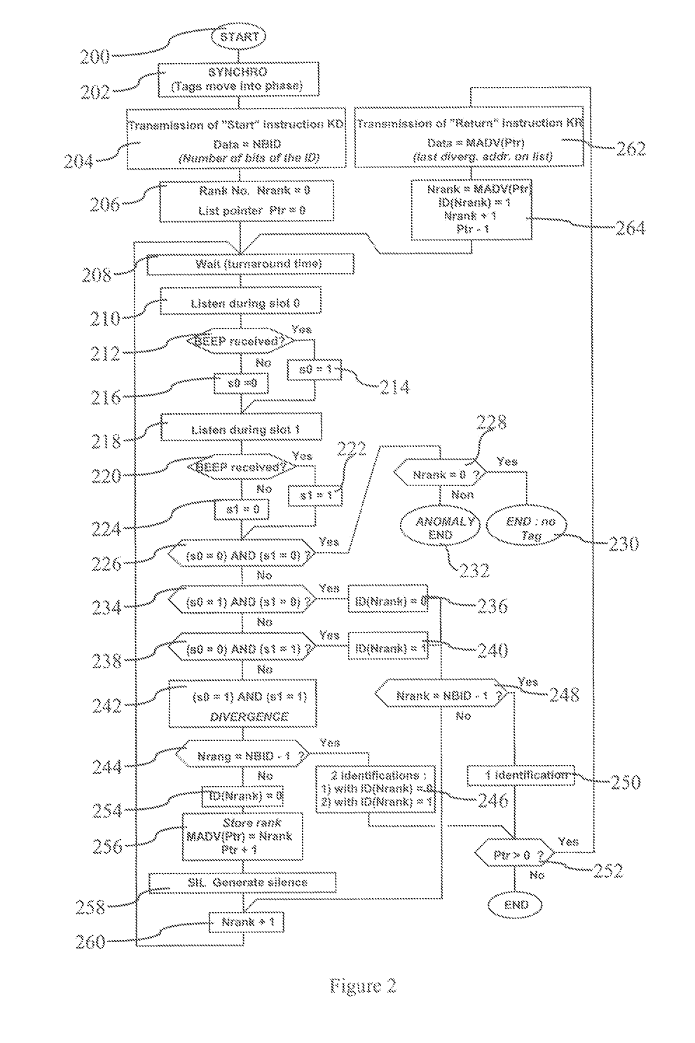

FIG. 2 represents a base station operation algorithm according to an embodiment of this invention;

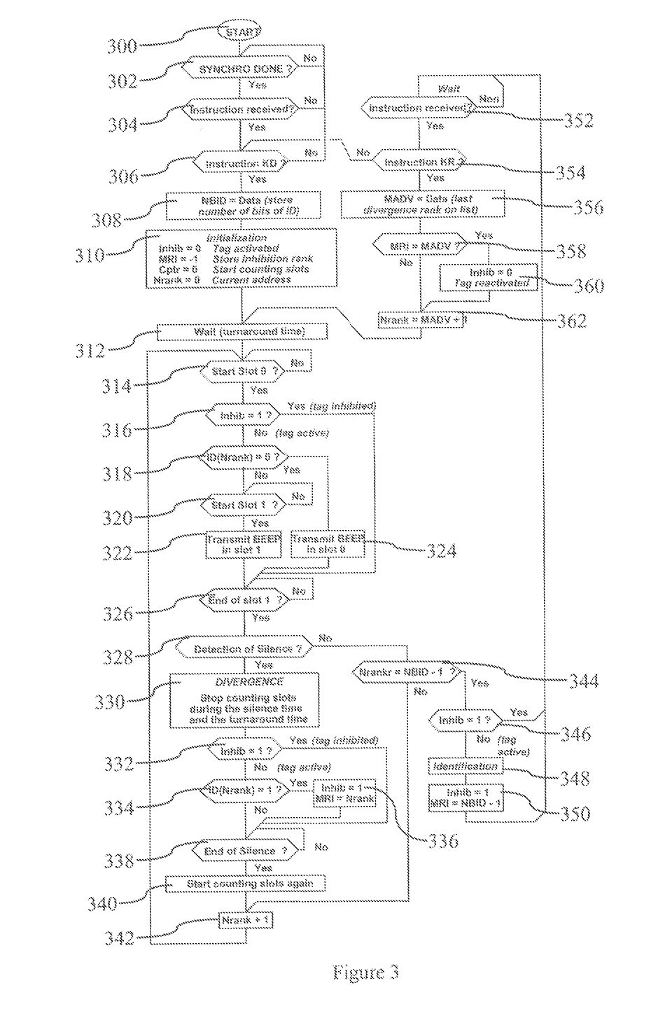

FIG. 3 represents a tag operation algorithm according to an embodiment of this invention;

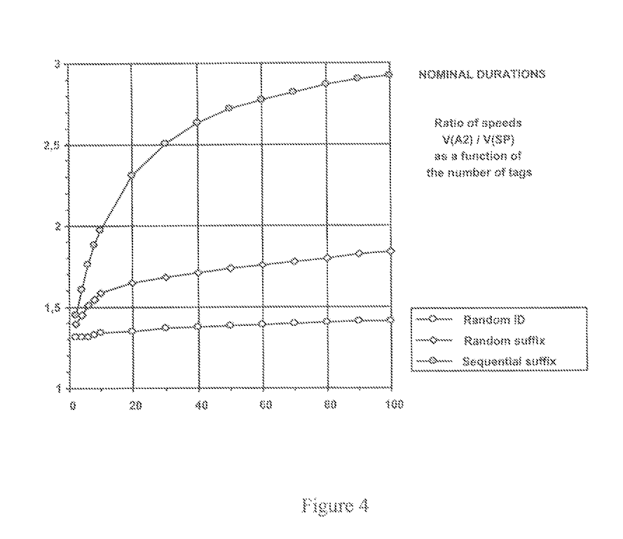

FIG. 4 represents an identification speed gain factor of the method subject of this invention compared with the fastest method currently known;

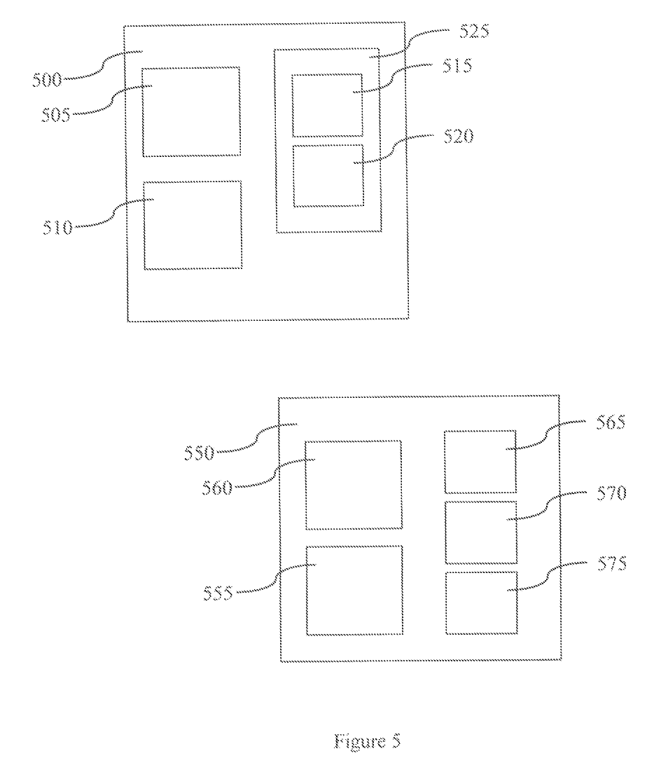

FIG. 5 represents a base station and a tag of a special embodiment of this invention and

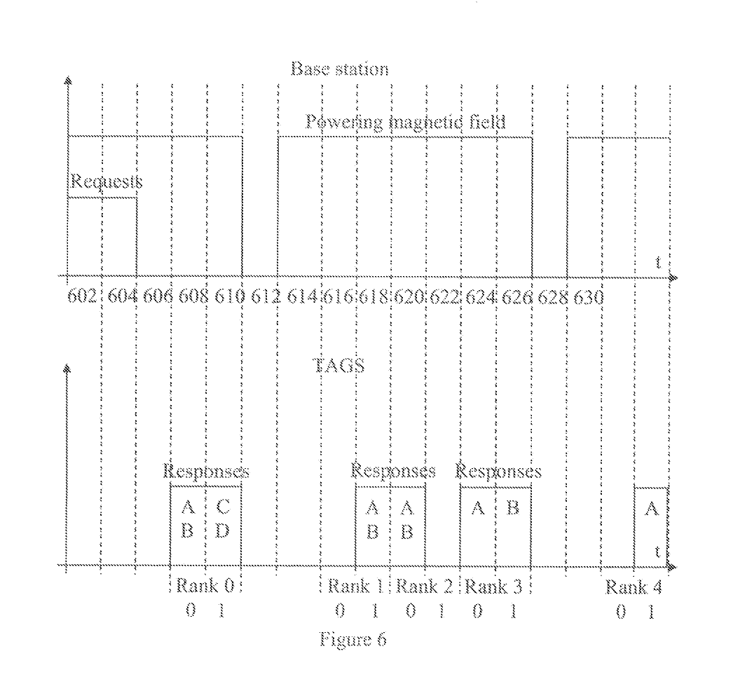

FIG. 6 represents a chronogram of signals exchanged between the base station and the electronic tags.

Throughout the description, a rank refers to the address of a tag identification code bit and slot or time slot refers to a predefined time interval during which a tag can transmit a signal in order to be identified.

The principle of the method subject of this invention is as follows:

the base station transmits a “Start” instruction (“KD”) which initializes the interrogation process and which is used to identify the electronic tag of lower code or identifier (“ID”). “Return” instructions (“KR”) are used to perform re-interrogations to identify the other tags, with one “KR” instruction for each tag identified;

after the “KD” and “KR” instructions, the identifiers (ID) are polled, bit by bit (row by rank), starting, for example, with the most significant bit (“MSB”) of rank “0” and ending with the least significant bit (“LSB”) of maximum rank (equal to the number of bits to be identified−1);

a pair of time slots (s0 and s1) is planned at each rank tested; the active tags respond by a “BEEP” in slot s0 if the value of their code at the rank considered is “0”. If the value of their code at the rank considered is “1”, they respond in slot s1;

the number of the read rank is incremented after each pair of slots, implicitly, i.e. without an explicit instruction being transmitted by the base station;

if there are only responses in slot s0, the base station stores the value “0” at the read rank considered;

if there are only responses in slot s1, the base station stores the value “1” at the read rank considered;

if several tags are active, since they cannot have the same identifier “ID”, the case known as “divergence” necessarily occurs in which, at a given rank, at least one tag responds in s0 while at least one tag responds in slot s1.

this divergence is indicated to the tags by a signal from the base station at the end of slot s1. This signal consists, for example, in producing a brief interruption in the carrier called a “silence”, this brief interruption of the carrier not requiring a resynchronization of the tag clocks. If there is no divergence, the base station does not transmit signals to the electronic tags. Silence and absence of silences represent implicit interrogation commands instructing the electronic tags to move to the next rank;

appearance of divergence results in the following actions:
after detection of the silence, the active (non-inhibited) tags which emitted a “BEEP” in slot s1 switch into inhibited state, i.e. they no longer respond to interrogations until they have received a new interrogation (“re-interrogation”) for this rank (see below) and store the rank at which inhibition occurred and
in the base station, increment of a list pointer and storage of the rank at which divergence was observed (without erasing the other divergence ranks already stored) and storage of value “0” at the read rank considered;

interrogation continues only for the non-inhibited tags (in the event of divergence, those which responded in slot s0 at the time of the divergence). If other divergences occur, the above procedure is repeated:

when the last rank has been processed, the last active tag is fully identified. It switches into permanent inhibition state and its code is stored by the base station in the list of codes identified;

a divergence could occur at the last rank, if two tags have “IDs” which are identical apart from the least significant bit (LSB), present at the last rank. In this case, the result is a double identification and the two tags switch into inhibition state, storing the last rank as inhibition rank. This divergence is not written in the base station list. No silence is generated for the last rank;

after identifying a tag, the base station returns to the last divergence rank written in its list (if the list is empty, there are no more tags to be identified). This rank number is sent to all inhibited tags. All tags whose inhibition rank memory is equal to the divergence rank sent by the base station are reactivated or “de-inhibited”. The base station erases the memory of the last divergence rank by decrementing its divergence rank list pointer and takes, as code section already identified, the code section of the previous tag identified which extends from the first rank to the rank preceding the divergence rank and adding, for the divergence rank, the value “1” (e.g., if the previous tag identified had code “01001011” . . . and the last divergence rank is the sixth rank, the code section already identified for the next tag being identified is, for the first six ranks, “010011”) and

reading of the tags resumes from the next rank (we know that the “IDs” of all the tags reactivated in this way are in state “1” at the divergence rank; there is therefore no need to poll this rank again). As previously, reading continues up to the last rank (LSB) with possibly new divergences, processed as previously.

The following instructions or commands are used:

“KD”: “Start” instruction. It is followed by an NBID data which indicates the number of ranks or bits of the identifiers “ID” (e.g. 32 bits), allowing the tags to know when polling has ended (row=NBID−1). All the tags within the field of the base station become active (Inhib=“0”). The rank counters (Nrank), and the tag inhibition rank memories (MRI), are reset. In the base station, the rank counter (Nrank), and the base station list pointer (Ptr), are reset.

“KR”: “Return” instruction. It is followed by an MRDV data which indicates the rank of the last divergence observed. This rank number is the value indicated by the pointer Ptr read in the base station, the pointer Ptr is then decremented. All tags whose inhibition rank memory MRI is equal to this divergence rank MRDV become active again. Their rank counters (Nrank) are incremented and interrogation resumes from MRDV+1 up to the last rank.

We observe that the same interrogation process is performed after the “KD” and “KR” instructions. After a fixed dead time including the turnaround time of the base station (which starts listening for the “BEEPS”), the clock count defines the time position of the slot pairs.

Only if a divergence is detected on a rank Nrank>NBID−1:

the base station produces a silence (SIL) which inhibits all tags which responded in slot s1 at the time of the divergence. These tags store the current rank in their inhibition rank memories (MRI=Nrank);

the base station increments its pointer Ptr and writes the divergence rank number in its list: MRDV(Ptr)=Nrank;

the rank is incremented;

polling continues, the time position of the next slots being shifted according to the silence transmission time and the associated timeouts.

If no divergence is detected, the base station produces no signals or silences and the electronic tags move to the next rank.

When the last rank (LSB) is reached (Nrank=NBID−1):

a tag is fully identified (or two tags if a divergence occurred on the LSB rank);

if the list pointer Ptr is at “0”, all tags have been identified (end of the process);

if the list pointer Ptr is not at “0”, a “Return” “KR” instruction is transmitted.

An example is given below of the exchanges made between a base station in accordance with this invention and a tag in accordance with this invention, for implementing the method subject of this invention.

The following example, with reference to FIG. 1, is limited to identifiers “ID” of length six bits (Nrank=0 to 5) and to a case where four tags labeled A to D are identified:

Nrank =

| | 0 | 1 | 2 | 3 | 4 | 5 |
|---|---|---|---|---|---|---|
| tag A | 0 | 1 | 0 | 0 | 1 | 0 |
| tag B | 0 | 1 | 0 | 1 | 1 | 1 |
| tag C | 1 | 0 | 1 | 0 | 0 | 1 |
| tag D | 1 | 1 | 0 | 1 | 0 | 0 |

During a step 102, the base station transmits a “KD” instruction: “Start” instruction. During an initialization step 104, all tags receiving the “KD” instruction are activated, their rank counters and their inhibition rank memories are set to “0”. During a step 106, the list pointer and the rank counter of the base station are set to “0”.

During a step 108, the number of bits of the identifier (NBID) is transmitted to the tags and polling starts at the first rank, rank “0”. During a step 110, since tags A and B respond in slot s0 and tags C and D respond in slot s1, divergence is detected at Nrank=0. During a step 112, since divergence occurred, the base station generates a silence, increments its pointer Ptr and writes in its memory the rank number of the first divergence MRDV(1)=Nrank=0.

Since the base station generated a silence, the tags which responded in slot s1, i.e. tags C and D (whose ID bit is equal to “1”), switch into inhibited state and store MRI=Nrank=0 during a step 114. Similarly, during a step 116, a second divergence is detected at Nrank=3, tag A responding in slot s0 and tag B in slot s1. During a step 118, the base station writes in its list MRDV(2)=3 and generates a silence. During a step 120, tag B, which responded in slot s1 switches into inhibited state and stores MRI=3.

For the next ranks, there are no more divergences and therefore no more silences generated by the base station until the next rank is reached and tag A is identified by the base station, during a step 122, and permanently switches into inhibited state until the next start instruction “KD”.

(in the following table, “X” represents a “BEEP” transmitted by the tag and “Inh” the fact that it switches into inhibited state)

| | | | Nrank: | | | | | | | | | | | | | |
|---|---|---|---|---|---|---|---|---|---|---|---|---|---|---|---|---|
| | | | 0 | | 0 | 1 | | 2 | | 3 | | 3 | 4 | | 5 | |
| Instructions | KD | 6 | s0 | s1 | SIL | s0 | s1 | s0 | s1 | s0 | s1 | SIL | s0 | s1 | s0 | s1 |
| Tag A | | | X | | | | X | X | | X | | | | X | X | |
| Tag B | | | X | | | | X | X | | | X | Inh | — | — | — | — |
| Tag C | | | | X | Inh | — | — | — | — | — | — | — | — | — | — | — |
| Tag D | | | | X | Inh | — | — | — | — | — | — | — | — | — | — | — |

During a step 124, the base station transmits a “KR” instruction, a “Return” instruction, followed by the last divergence rank number written in the list: MRDV(2)=3. The pointer is decremented and returns to Ptr=1.

During a step 126, tag B for which MRI=MRDV=3 reactivates. Interrogation resumes at rank: Nrank=MRDV+1=4 and continues up to the last rank, without divergence. Tag B is identified by the base station and permanently switches into inhibited state until the next start instruction “KD”.

Nrank:

| | | |
|---|---|---|
| 4 | 5 | 5 |

| Instructions | KR | 3 | s0 | s1 | s0 | s1 | SIL |
|---|---|---|---|---|---|---|---|
| Tag B | | | | X | | X | |
| Tag C | | | | | | | |
| Tag D | | | | | | | |

During a step 128, the base station transmits a “KR” instruction, a “Return” instruction, followed by the divergence rank number written in the list: MRDV(2)=0. The pointer is decremented and returns to Ptr=0.

During a step 130, tags C and D for which MRI=MRDV=0 reactivate. Interrogation resumes at rank: Nrank=MRDV+1=1. During a step 132, a divergence is detected at Nrank=1 and the base station generates a silence. During a step 134, tag D, which responded in slot s1 switches into inhibited state and stores MRI=1. During a step 136, the base station increments its pointer and writes MRDV(1)=1.

During a step 138, interrogation continues up to the last rank without further divergence. Tag C is identified and permanently switches into inhibited state until the next start instruction “KD”.

| | | | Nrank: | | | | | | | | | | | |
|---|---|---|---|---|---|---|---|---|---|---|---|---|---|---|
| | | | 1 | | 1 | 2 | | 3 | | 4 | | 5 | | 5 |
| Instructions | KR | 0 | s0 | s1 | SIL | s0 | s1 | S0 | s1 | s0 | s1 | s0 | s1 | SIL |
| Tag C | | | X | | | | X | X | | X | | | X | |
| Tag D | | | | X | Inh | — | — | — | — | — | — | — | — | — |

During a step 140, the base station transmits a “KR” instruction, a “Return” instruction, followed by the last divergence rank number written in the list: MRDV(2)=1. The pointer is decremented and returns to Ptr=0.

During a step 142, tag D for which MRI=MRDV=1 reactivates. Interrogation resumes at rank: Nrank=MRDV+1=2. Interrogation continues, without divergence, up to the last rank. During a step 144, tag D is identified and permanently switches into inhibited state until the next start instruction “KD”.

Since pointer Ptr=0, the process is finished, all tags have been identified.

| | | | Nrank: | | | | | | | | |
|---|---|---|---|---|---|---|---|---|---|---|---|
| | | | 2 | | 3 | | 4 | | 5 | | 5 |
| Instructions | KR | 1 | s0 | s1 | s0 | s1 | s0 | s1 | s0 | s1 | SIL |
| Tag D | | | X | | | X | X | | X | | |

FIG. 2 represents a base station operation algorithm.

During a step 200, the base station is initialised. During a step 202, the tags synchronize and move into phase (see document EP 0 777 192). During a step 204, the base station transmits a start instruction “KD” indicating the number of identification code bits NBID. During a step 206, the base station sets the variable Nrank and the list pointer Ptr to “0”. During a step 208, the base station performs a wait step (equal to the turnaround time). During a step 210, the base station waits for the end of slot s0. During a step 212, the base station determines whether it received a “BEEP” signal during slot s0. If yes, during a step 214, variable s0 is set to “1”. Otherwise, during a step 216, variable s0 is set to “0”.

During a step 218, the base station waits for the end of slot s1. During a step 220, the base station determines whether it received a “BEEP” signal during slot s1. If yes, during a step 222, variable s1 is set to “1”. Otherwise, during a step 224, variable s1 is set to “0”.

During a step 226, the base station determines whether variables s0 and s1 both have value “0”. If yes, during a test 228, the base station determines whether the variable “Nrank” is “0”. If yes, during a step 230, the base station concludes that there is no active tag within range. Otherwise, during a step 232, the base station determines whether an anomaly has occurred and stops its operation, for example returning to step 200.

If the result of test 226 is negative, during a step 234, the base station determines whether variable s0 is “1” and whether variable s1 is “0”. If yes, during a step 236, ID(Nrank)=0 is stored. This table represents the values of the ID bits during identification.

Otherwise, during a step 238, the base station determines whether variable s0 is “0” and whether variable s1 is “1”. If yes, during a step 240, ID(Nrank)=1 is stored. In both cases, the tags which responded are not inhibited.

However, if during a step 242, the base station received responses during each of slots s0 and s1, it determines whether “divergence” occurred, i.e. whether the tags which responded are located on two branches of the identification code tree which split at the rank Nrank considered. In this case, during a step 244, the base station determines whether the rank Nrank is equal to NBID−1 (number of bits of the identifier minus one). If yes, during step 246, two tags are identified, whose identifiers are identical apart from the last bit. If no, during a step 254, the value of the bit for the rank considered and for the tags which will continue to respond (i.e. those which will not switch into inhibited state) is equal to “0”: ID(Nrank)=0. Then, during a step 256, the rank number considered is stored and the variable MRDV(Ptr) takes the value Nrank and the pointer Ptr is incremented by 1.

During a step 258, the base station generates a silence “SIL” and, during a step 260, the variable Nrank is incremented.

After one of steps 236 or 240, during a step 248, the base station determines whether the variable Nrank=NBID−1. Otherwise, step 260 is performed. If yes, during a step 250, a tag is identified, i.e. its code is fully known. After one of steps 246 or 250, during a test 252, the base station determines whether the value of pointer Ptr is greater than “0”. Otherwise, the tag recognition and identification process is finished and the base station can return to step 200. If yes, during a step 262, the base station transmits a return instruction “KR”, supplying as data the value of variable MRDV(Ptr), i.e. the rank number of the last divergence in the divergence rank list. Then, during a step 264, variable Nrank is set to the value MRDV(Ptr), ID(Nrank)=1 is stored, variable Nrank is incremented and variable Ptr is decremented. The base station then returns to step 208.

FIG. 3 represents an operation algorithm of each tag.

During a step 300, the tag receives a signal from a base station allowing it to receive the energy required for its operation and initializes. During a step 302, the tag determines whether it has synchronized (see document EP 0 777 192). Otherwise, it returns to step 302. If yes, during a step 304, the tag determines whether it has received an instruction. Otherwise, it returns to step 302. If yes, during a step 306, it determines whether the instruction received is a start instruction “KD”. Otherwise, it returns to step 302. If yes, during a step 308, the tag initializes the value of a variable NBID indicating the number of identifier bits supplied by the base station. Then, during a step 310, the tag initializes:
variable “Inhib” to value “0” indicating that the tag has been activated,
variable “MRI” to value “−1”, MRI representing an inhibition rank number and “−1” a value indicating that no inhibition has yet taken place,
variable CPtr to value “0”, CPtr being the slot counter and
the rank number Nrank being interrogated is set to 0.

During a step 312, the tag waits for the end of the turnaround time. During a step 314, the tag determines whether slot s0 has started. Otherwise, step 314 is repeated. If yes, during a step 316, the tag determines whether it is in inhibited state (Inhib=1). If yes, the tag moves to a step 328 described below. Otherwise, during a step 318, the tag determines whether, at the rank number indicated by Nrank, the bit read on its identifier is “0”. If yes, during a step 324, the tag transmits a “BEEP” signal during slot s0. Otherwise, during a step 320, the tag determines whether slot s1 has started. Otherwise, step 320 is repeated. If yes, during a step 322, the tag transmits a “BEEP” signal during slot s1.

After one of steps 322 or 324, during a step 326, the tag determines whether slot s1 has finished. Otherwise, step 326 is repeated. If yes, during a step 328, the tag determines whether it detects a silence “SIL”. If yes, during a step 330, the tag is notified that a divergence has been detected by the base station. It stops counting the slots during the silence time and the turnaround time. Then, during a step 332, the tag determines whether the variable “Inhib” is “1”. If yes, it moves to step 338 described below. Otherwise, during a step 334, the tag determines whether the value of its identification code for the rank considered is “1”. Otherwise, it moves to step 338. If yes, during a step 336, the tag sets its variable “Inhib” to “1” and its variable “MRI” to the value of the variable “Nrank”, then moves to step 338. During a step 338, the tag determines whether the silence and the turnaround time have finished. Otherwise, step 338 is repeated. If yes, during a step 340, the tag starts counting the slots again and, during a step 342, the value of the variable “Nrank” is incremented and the tag returns to step 314.

If the result of test 328 is negative (no silence is detected), during step 344, the tag determines whether the variable “Nrank” is equal to NBID−1. Otherwise, the tag performs step 342. If yes, during a step 346, the tag determines whether its variable “Inhib” is “1”. If yes, it performs step 352 described below. Otherwise (i.e. if the tag is active), during a step 348, the tag knows that it has been fully identified and, during a step 350, the variable “Inhib” is set to “1” and the variable “MRI” is set to the value NBID−1.

During step 352, the tag determines whether an instruction has been received. Otherwise, step 352 is repeated. If yes, during a step 354, the tag determines whether the instruction received is a return instruction “KR”. Otherwise, step 306 is repeated. If yes, during a step 356, the variable “MRDV” takes the value supplied by the instruction KR, i.e. the rank number of the last divergence on the list of divergences stored by the base station. Then, during a step 358, the tag determines whether the value of the variable “MRI” is equal to the value of the variable “MRDV”. If yes, during a step 360, the value of the variable “Inhib” is set to “0”, i.e. the tag is reactivated. After step 360, or if the result of step 358 is negative, during a step 362, the variable “Nrank” is set to the value MRDV+1 and step 312 is repeated.

The inventor has compared the identification speed of the fastest algorithm currently known on the market with that of the algorithm described with reference to FIGS. 1 to 3, for three types of identifier ID and for a number of tags ranging from two to one hundred. This comparison indicates a time saving factor illustrated in FIG. 4.

With the nominal durations and 100 tags, the algorithm described improves the speed by a factor of at least 1.41 compared with the traditional algorithm with a random identifier. This improvement reaches 1.83 when the identifier has a constant prefix and a random suffix of 9 bits. This factor increases up to 2.92 when the identifier is sequential.

FIG. 5 shows a base station 500 including a control and command module 505, an antenna 510, a database 515 and operation instructions 520 in a non volatile memory 525 and a memory for variables 530. FIG. 5 also shows a tag 550 including an antenna 555, a processor 560, a code memory 565, a memory for variables 570 and a program memory 575.

The operation instructions 520 implement one of the embodiments of the method subject of this invention, for example the embodiment illustrated on FIG. 1 or the embodiment illustrated on FIG. 2.

The program memory 575 stores a tag operation program 550, implementing one of the embodiments of the method subject of this invention, for example the embodiment illustrated on FIG. 1 or the embodiment illustrated on FIG. 3.

As a variant, the code may take more than two different values in one rank or more than one rank of the code is interrogated during an interrogation step. In this case, the number of time slots following an interrogation step is increased to correspond to the number of possible responses and after the de-inhibition step, the de-inhibited tags transmit their responses for the inhibition rank. We see that, in this case, the silence which indicates that a divergence has occurred is located after the first slot for which a response is received by the base station so that the tags can determine whether or not they should switch into inhibited state. According to a sub-variant, after a response from the tags, the base station transmits a signal representative of the lowest value for said rank so that the tags can determine whether or not they should switch into inhibited state.

FIG. 6 shows a chronogram of signals exchanged between the base station and the electronic tags which, in the example given here, have the same identifiers as previously:

Nrank =

| | 0 | 1 | 2 | 3 | 4 | 5 |
|---|---|---|---|---|---|---|
| tag A | 0 | 1 | 0 | 0 | 1 | 0 |
| tag B | 0 | 1 | 0 | 1 | 1 | 1 |
| tag C | 1 | 0 | 1 | 0 | 0 | 1 |
| tag D | 1 | 1 | 0 | 1 | 0 | 0 |

In FIG. 6, the scales are not respected. To give an idea, in the prototype produced by the inventor, which operates with a magnetic field of frequency 125 kHz, the response time is 1 ms, the silence time is 0.05 ms and the turnaround time is 1.2 ms.

The top part of FIG. 6 concerns the signals transmitted by the base station and the bottom part of FIG. 6 concerns the signals transmitted by the electronic tags considered jointly as a group. In the top part concerning the base station, the highest signal represents the transmission of a magnetic field used to power the electronic tags and the silences or temporary interruptions of this field to indicate the presence of a divergence. In the top part concerning the base station, the lowest signal represents the time intervals for transmission of explicit requests. In the bottom part concerning the electronic tags, a signal represents the time intervals during which at least one electronic tag transmits a signal to indicate to the base station the value of its code in a rank. The transmitting tags are indicated by letters “A”, “B”, “C” and “D” in the transmission time intervals. Below the bottom part, the figure shows the rank concerned by each response and, on the line underneath, the meaning of the responses transmitted.

During a first phase 602, starting randomly at the time origin, during which the base station transmits an electronic tag initialization request. Then, during a phase 604, the base station transmits, to the tags initialised, a request to interrogate their first code rank.

During a phase 606, the electronic tags reserve a turnaround time allowing the base station to start listening for their responses.

During a step 608, tags “A” and “B” transmit a response indicating that they have the value “0” in the first rank of their identifiers.

During a step 610, tags “C” and “D” transmit a response indicating that they have the value “1” in the first rank of their identifiers.

During a step 612, since a divergence occurred, the base station transmits a silence indicating that it has received responses representing different code values, which temporarily inhibits tags “C” and “D”.

During a phase 614, the electronic tags reserve a turnaround time allowing the base station to start listening for their responses.

During a step 616, no tag is transmitting since tags “C” and “D” are inhibited and tags “A” and “B” do not have value “0” in the second rank of their identifiers.

During a step 618, tags “A” and “B” transmit a response indicating that they have the value “1” in the second rank of their identifiers.

Since no divergence occurred, the base station does not transmit any silences, which indicates that it has received responses representing the same code value, which does not cause any new temporary tag inhibition.

During a step 620, tags “A” and “B” detect that no silence has been transmitted by the base station and, without reserving the turnaround time, transmit a response indicating that they have value “0” in the third rank of their identifiers.

During a step 622, no tag is transmitting since tags “C” and “D” are inhibited and tags “A” and “B” do not have value “1” in the third rank of their identifiers.

Since no divergence occurred, the base station does not transmit any silences, which indicates that it has received responses representing the same code value, which does not cause any new temporary tag inhibition.

During a step 624, tag “A” detects that no silence has been transmitted by the base station and, without reserving the turnaround time, transmits a response indicating that it has value “0” in the fourth rank of its identifier.

During a step 626, tag “B” transmits a response indicating that it has the value “1” in the fourth rank of its identifier.

During a step 628, since a divergence occurred, the base station transmits a silence indicating that it has received responses representing different code values, which temporarily inhibits tag “B”.

During a phase 630, tag “A” reserves a turnaround time allowing the base station to start listening for its response. The remaining exchanges between the base station and the tags are not described here.

With reference to FIG. 6, we observe that the feature of this invention according to which, upon reception of responses from the electronic tags by the base station, during a transition step to move to the next rank, the base station only transmits a signal to the electronic tags if the responses from the electronic tags represent at least two different code values for the rank interrogated.

This saves a considerable amount of time when identifying the electronic tags, in addition to the time saved by storing inhibition ranks in order to know a section of code of the electronic tags, here tag “B” for which the three code values for at least the first three ranks are already known.

In fact, the time required to interrogate a rank where divergence has occurred is the sum of:
twice the electronic tag response time,
the silence time,
the turnaround time.

However, the time required to interrogate a rank where no divergence has occurred is only equal to the sum of:
twice the electronic tag response time and
the time to detect absence of silence (time less than or equal to the silence time).

We also see that the total number of divergences encountered when identifying a number n of electronic tags is equal to n−1. The time saving gained by the feature of the invention indicated above therefore increases with the number of ranks to be interrogated.

Although, in the description, it is the tags with a “1” in a rank where a divergence is detected which switch into inhibited state, this invention is not limited to this case and extends to the case where it is the tags with a “0” in a rank where a divergence is detected which switch into inhibited state. Similarly, the meaning of the successive time intervals can be reversed and the code interrogation direction, in ascending order, can be reversed without leaving the scope of this invention.

1. A method for identifying electronic tags equipped with a memory of an identification code specific to each tag, this code including a certain number of ranks, identified by a base station able to transmit interrogation commands explicit or implicit, specifying at least one rank of said code, each tag within the range of the base station being able to transmit, in response to an interrogation command, a signal representative of the value of its code for each said rank the method comprising:
an interrogation step to interrogate the electronic tags and, on reception by the base station of the responses from the electronic tags, for at least one code rank, a transition step to move to the next rank during which the base station only transmits a signal to the electronic tags if the responses from the electronic tags represent at least two different code values for the rank interrogated:
when the base station has indicated that it has received responses representative of at least two different code values for the rank interrogated:
an inhibition step to temporarily inhibit the tags which have a predetermined code value for said interrogated rank, inhibition step after which said tag no longer responds to the interrogations until it receives a de-inhibition instruction, and
a storage step to store said rank in the tags performing the inhibition step,
for each stored inhibition rank, at least one subsequent re-interrogation step concerning said stored inhibition rank and, in response to said re-interrogation, for each tag which has stored said inhibition rank:
a de-inhibition step and
a response step representative of the value of its code in this rank or in another rank, the base station associating with each said tag a section of code common to all the tags performing said response step.

2. The method according to claim 1, wherein the signal transmitted by the base station on reception of the responses from the electronic tags is a silence signal during which the base station stops transmitting a magnetic field.

3. The method according to claim 2, wherein the magnetic field which is no longer transmitted by the base station during the signal transmitted by the base station on reception of the responses from the electronic tags is a magnetic field powering the electronic tags.

4. The method according to claim 1 wherein the base station performs the subsequent re-interrogation steps starting with the last inhibition rank then performing a series of interrogations steps until at least one tag has been fully identified.

5. The method according to claim 1 wherein when the code of a tag has been fully identified, said tag performs a permanent inhibition step after which said tag no longer responds to the interrogations before receiving a de-inhibition instruction.

6. The method according to claim 1 wherein at each interrogation step the tags determine their response transmission time according to the value of their code for the rank concerned by the response.

7. The method according to claim 1 wherein at the start of a re-interrogation the tags transmit a response which concerns the rank after that for which inhibition took place.

8. An electronic tag equipped with a memory of an identification code specific to each tag, this code including a certain number of ranks, identified by a base station able to transmit interrogation commands explicit or implicit, specifying at least one rank of said code, each tag within the range of the base station being able to transmit, in response to an interrogation command, a signal representative of the value of its code for each said rank the electronic tag comprising:
a response module to respond to an electronic tag interrogation by the base station, for at least one code rank, and, for each interrogation:
a control module able to detect a signal transmitted by the base station only if the base station has received responses representative of at least two different code values for the rank interrogated and, if this signal is detected, to determine whether said tag has a predetermined code value for said rank and, in this case, to inhibit the electronic tag, i.e. prevent it from responding to the interrogations until it receives a de-inhibition instruction,
an inhibition rank memory in which the control module stores the code rank at which the tag may have switched into inhibited state.

9. The electronic tag according to claim 8, wherein the control module is able to detect that the signal transmitted by the base station to indicate that the base station has received responses representative of at least two different code values is a silence signal during which the base station stops transmitting a magnetic field.

10. The electronic tag according to claim 9, wherein the control module is able to detect said signal on the magnetic field powering the electronic tags transmitted by the base station.

11. The tag according to claim 8 wherein the control module is able, in response to a new interrogation concerning the inhibition rank to de-inhibit said tag.

12. The tag according to claim 11 wherein, when the tag switches into de-inhibited state it transmits a response representative of the value of its code at the rank after the inhibition rank.

13. A base station to identify electronic tags equipped with a memory of an identification code specific to each tag, this code including a certain number of ranks, said base station being able to transmit interrogation commands explicit or implicit, specifying at least one rank of said code, each tag within the range of the base station being able to transmit, in response to an interrogation command, a signal representative of the value of its code for each said rank the base station comprising:
a storage module to store each “divergence” rank for which at least two tags have transmitted two different responses to said interrogation,
a communication module able, on reception by the base station of the responses from the electronic tags, for at least one code rank, to only transmit a signal from the base station to the electronic tags if the responses from the electronic tags represent at least two different code values for the rank interrogated;
control module able to re-interrogate the tags for each divergence rank stored and to associate with their response a section of code common to all the tags responding to said re-interrogation.

14. The base station according to claim 13, wherein the signal transmitted by the base station on reception of the responses from the electronic tags is a silence signal during which the base station stops transmitting a magnetic field.

15. The base station according to claim 14 wherein, the magnetic field which is no longer transmitted by the base station during the signal transmitted by the base station on reception of the responses from the electronic tags is a magnetic field powering the electronic tags.

16. The base station according to claim 13 wherein the control module are able to perform re-interrogations starting with the last inhibition rank then performing a series of interrogation steps until at least one tag has been fully identified.
